(19) United States
(12) Patent Application Publication
(10) Pub. No.: US 2018/0025818 A1
(43) Pub. Date: Jan. 25, 2018

(54) SINTERED R-TM-B MAGNET

(71) Applicant: HITACHI METALS, LTD., Tokyo (JP)

(72) Inventors: Daisuke YAMAMICHI, Kumagaya-shi (JP); Masanao KAMACHI, Kumagaya-shi (JP); Rintaro ISHII, Mishima-gun (JP); Takahiro KATOU, Kumagaya-shi (JP)

(73) Assignee: HITACHI METALS, LTD., Tokyo (JP)

(21) Appl. No.: 15/549,777

(22) PCT Filed: Mar. 22, 2016
(86) PCT No.: PCT/JP2016/058917

§ 371 Date: Aug. 9, 2017

(30) Foreign Application Priority Data
Mar. 27, 2015 (JP) 2015-066185

(51) Int. Cl. H01F 1/057; C22C 38/06; C22C 38/16; C22C 38/00; C22C 38/10

(52) U.S. Cl. CPC H01F 1/0577; C22C 38/005; C22C 38/10; C22C 38/16; C22C 38/06; C22C 33/02

(57) ABSTRACT

A sintered R-TM-B magnet comprising 24.5-34.5% by mass of R, which is at least one selected from rare earth elements including Y, 0.85-1.15% by mass of B, less than 0.1% by mass of Co, 0.07-0.5% by mass of Ga, and 0-0.4% by mass of Cu, the balance being Fe and inevitable impurities; the amounts (% by mass) of Ga and Cu being in a region of a pentagon defined by a point A (0.5, 0.0), a point B (0.5, 0.4), a point C (0.07, 0.4), a point D (0.07, 0.1) and a point E (0.2, 0.0), on an X-Y plane in which the X-axis represents the amount of Ga, and the Y-axis represents the amount of Cu.

### FIELD OF THE INVENTION

The present invention relates to a sintered R-TM-B magnet having improved corrosion resistance, and an anisotropic, cylindrical, sintered R-TM-B magnet suffering less breakage.

### BACKGROUND OF THE INVENTION

Sintered R-TM-B magnets having high magnetic properties are widely used, though they are vulnerable to corrosion because they contain rare earth elements (R elements) as main components. It is known that corrosion starts from rare-earth-rich phases, and proceeds with the main phases detached successively. Though corrosion-resistant coatings are usually formed (painted or plated) on the sintered R-TM-B magnets to prevent corrosion, they are water-vapor-permeable to some extent, failing to completely prevent the corrosion of the magnets.

Polar-anisotropic, cylindrical magnets and radially anisotropic, cylindrical magnets are known as typical forms of the sintered R-TM-B magnets. The use of these cylindrical magnets for rotors makes assembling easy, because they need not be attached to rotors one by one unlike arcuate magnets.

However, these cylindrical magnets are likely to have internal stress, which is generated by different linear thermal expansion coefficients due to anisotropy between a direction parallel to the C-axis and a direction perpendicular to the C-axis. When this stress exceeds the mechanical strength of cylindrical magnets, breakage and cracking occur as described, for example, in JP 64-27208 A. In the case of block-shaped magnets, though, stress would be released from them even with different linear thermal expansion coefficients.

Co is known as a metal for improving the corrosion resistance of the sintered R-TM-B magnets. For example, JP 63-38555 A describes that Co is taken in main phases and grain boundaries of the sintered R-TM-B magnets, forming its intermetallic compounds with rare earth elements, which are more corrosion-resistant than the rare-earth-rich phases. However, Co contained not only in the main phases but also in the grain boundary phases deteriorates mechanical strength. Thus, the sintered R-TM-B magnets containing Co are likely to suffer chipping and cracking in handling and grinding, resulting in low production efficiency.

JP 2003-31409 A discloses the addition of Co and Cu which are segregated around R-rich phases (rare-earth-element-rich grain boundary phases) to coat the R-rich phases with intermediate phases comprising Co and Cu, thereby improving the corrosion resistance of individual R-rich phases. However, because Co provides the sintered magnet with low mechanical strength as in JP 63-38555 A, a technology of improving the corrosion resistance of magnets, particularly cylindrical magnets having internal stress, is desired.

JP 2013-216965 A discloses an alloy for a sintered R-T-B rare earth magnet, which comprises a rare earth element R, a transition metal T including Fe as an indispensable element, one or more metal elements M selected from Al, Ga and Cu, B, and inevitable impurities. However, it describes neither the improvement of corrosion resistance and strength, nor the use of the sintered R-T-B rare earth magnet alloy for cylindrical magnets.

Because the addition of Co provides sintered R-TM-B magnets with lower mechanical strength despite improved corrosion resistance as described above, particularly polar-anisotropic, cylindrical magnets and radially anisotropic, cylindrical magnets are likely to suffer breakage, chipping and cracking when containing Co. Accordingly, a sufficient amount of Co cannot be added to have enough corrosion resistance, and cylindrical magnets should have large sizes (radial sizes) to have enough mechanical strength.

### OBJECTS OF THE INVENTION

Accordingly, an object of the present invention is to provide a sintered R-TM-B magnet having high mechanical strength and excellent corrosion resistance without containing Co.

Another object of the present invention is to provide an anisotropic, cylindrical, sintered R-TM-B magnet suffering less breakage, chipping and cracking.

### SUMMARY OF THE INVENTION

As a result of intensive research in view of the above objects, the inventors have found that sintered R-TM-B magnets containing Ga or (Ga+Cu) exhibit excellent corrosion resistance without scarifying mechanical strength, and suffer less breakage, chipping, cracking, etc. even when formed into anisotropic cylindrical sintered magnets likely having large residual stress, even when they contain substantially no Co. The present invention has been completed based on such finding.

Thus, the sintered R-TM-B magnet of the present invention comprises 24.5-34.5% by mass of R, which is at least one selected from rare earth elements including Y, 0.85-1.15% by mass of B, less than 0.1% by mass of Co, 0.07-0.5% by mass of Ga, and 0-0.4% by mass of Cu, the balance being Fe and inevitable impurities; the amounts (% by mass) of Ga and Cu being in a region of a pentagon defined by a point A (0.5, 0.0), a point B (0.5, 0.4), a point C (0.07, 0.4), a point D (0.07, 0.1) and a point E (0.2, 0.0), on an X-Y plane in which the X-axis represents the amount of Ga, and the Y-axis represents the amount of Cu.

The sintered R-TM-B magnet of the present invention may further contain 3% or less by mass of M, which is at least one selected from Zr, Nb, Hf, Ta, W, Mo, Al, Si, V, Cr, Ti, Ag, Mn, Ge, Sn, Bi, Pb and Zn.

The amounts (% by mass) of Ga and Cu are preferably in a region of a pentagon defined by a point A (0.5, 0.0), a point B (0.5, 0.4), point C′ (0.1, 0.4), point D′ (0.1, 0.1) and a point E (0.2, 0.0), on an X-Y plane in which the X-axis represents the amount of Ga, and the Y-axis represents the amount of Cu.

The sintered R-TM-B magnet is preferably a radially anisotropic, cylindrical magnet or a polar-anisotropic, cylindrical magnet.

### Effects of the Invention

With Ga and Cu added in proper ranges in place of Co to improve corrosion resistance, the sintered R-TM-B magnets of the present invention exhibit high mechanical strength and excellent corrosion resistance, while suffering less breakage, chipping, cracking, etc. Accordingly, they may be formed into anisotropic, cylindrical, sintered R-TM-B magnets (radially anisotropic, cylindrical magnets and polar-anisotropic, cylindrical magnets) likely having residual stress. The sintered R-TM-B magnets of the present invention are suitably used for rotor magnets.

### BRIEF DESCRIPTION OF THE DRAWINGS

FIG. 1 is a graph showing the ranges of the amounts of Cu and Ga contained in the sintered R-TM-B magnet of the present invention.

FIG. 2(a) is a SEM photograph showing the corrosion of Alloy 1 (Ga/Cu=0.1/0.02% by mass) after the pressure cooker test in Experiment 3.

FIG. 2(b) is an SEM photograph showing the corrosion of Alloy 4 (Ga/Cu=0.5/0.4% by mass) after the pressure cooker test in Experiment 3.

FIG. 3 is a schematic view showing a molding apparatus of the radially anisotropic R-TM-B ring magnet used in Experiment 4.

FIG. 4(a) is a cross-sectional view schematically showing a molding apparatus of the polar-anisotropic R-TM-B ring magnet used in Experiment 5.

FIG. 4(b) is a cross-sectional view taken along the line A-A in FIG. 4(a).

### DESCRIPTION OF THE PREFERRED EMBODIMENTS

(1) Composition

The sintered R-TM-B magnet of the present invention comprises 24.5-34.5% by mass of R, wherein R is at least one selected from rare earth elements including Y, 0.85-1.15% by mass of B, less than 0.1% by mass of Co, 0.07-0.5% by mass of Ga, and 0-0.4% by mass of Cu, the balance being Fe and inevitable impurities; the amounts (% by mass) of Ga and Cu being in a region of a pentagon defined by a point A (0.5, 0.0), a point B (0.5, 0.4), a point C (0.07, 0.4), a point D (0.07, 0.1) and a point E (0.2, 0.0), on an X-Y plane in which the X-axis represents the amount of Ga, and the Y-axis represents the amount of Cu.

The sintered R-TM-B magnet of the present invention is preferably composed substantially of R-TM-B. R represents at least one of rare earth elements including Y, preferably indispensably containing at least one of Nd, Dy and Pr, and TM represents at least one of transition metal elements, preferably Fe. B is boron.

The sintered R-TM-B magnet comprises 24.5-34.5% by mass of R. When the amount of R is less than 24.5% by mass, the magnet has low residual magnetic flux density Br and coercivity iHc. When the amount of R is more than 34.5% by mass, rare-earth-rich phases are dominant in the sintered body, resulting in low residual magnetic flux density Br and corrosion resistance.

The sintered R-TM-B magnet comprises 0.85-1.15% by mass of B. When the amount of B is less than 0.85% by mass, B is insufficient to form main phases of R₂Fe₁₄B, so that non-magnetic R₂Fe₁₇ phases are formed, resulting in low coercivity. On the other hand, when the amount of B is more than 1.15% by mass, non-magnetic B-rich phases increase, resulting in a low residual magnetic flux density.

The sintered R-TM-B magnet comprises 0.07-0.5% by mass of Ga. Ga increases not only coercivity but also corrosion resistance. When Ga is less than 0.07% by mass, the coercivity iHc is not improved. On the other hand, the addition of more than 0.5% by mass of Ga would not further improve coercivity and corrosion resistance. Though the addition of 0.07% or more by mass of Ga provides sufficient improvement in corrosion resistance, it is more preferable to add 0.1% or more by mass of Ga. Particularly when Cu is not contained, the Ga content is preferably 0.2% or more by mass.

The sintered R-TM-B magnet comprises 0-0.4% by mass of Cu. Though the effects of the present invention can be obtained by adjusting the amount of Ga without containing Cu, the addition of Cu further improves corrosion resistance. When the Ga content is 0.07% by mass, 0.1% or more by mass of Cu is preferably contained. The addition of more than 0.4% by mass of Cu would not provide further improvement in corrosion resistance.

To obtain sufficient effect of improving corrosion resistance by Ga and Cu in the sintered R-TM-B magnet, the amounts (% by mass) of Ga and Cu are set in a region of a pentagon defined by a point A (0.5, 0.0), a point B (0.5, 0.4), a point C (0.07, 0.4), a point D (0.07, 0.1) and a point E (0.2, 0.0), on an X-Y plane in which the X-axis represents the amount of Ga, and the Y-axis represents the amount of Cu. With Ga and Cu in amounts within this region, sintered R-TM-B magnets having necessary magnetic properties and corrosion resistance can be obtained, with substantially no Co contained. The term “substantially” is used herein to permit the inclusion of Co as an inevitable impurity.

The amounts of Ga and Cu are preferably in a region of a pentagon defined by a point A (0.5, 0.0), a point B (0.5, 0.4), point C′ (0.1, 0.4), point D′ (0.1, 0.1) and a point E (0.2, 0.0), more preferably in a region of a quadrangle defined by a point A (0.5, 0.0), a point B (0.5, 0.4), a point C″ (0.2, 0.4) and a point D″ (0.2, 0.1), on the X-Y plane.

Though part of Fe may be substituted by Co, the inclusion of 0.1% or more by mass of Co undesirably increases breakage particularly in anisotropic cylindrical sintered magnets. Accordingly, the Co content is preferably less than 0.1% by mass. Though Co may be usually contained in the sintered R-TM-B magnet to improve corrosion resistance, the addition of Co is not indispensable, because the corrosion resistance is improved by Ga or Ga and Cu in the present invention as described above. However, 0.08% or less by mass of Co may be contained as an inevitable impurity in Fe. Though the amount of Co contained as an inevitable impurity is desirably as small as possible, Co is introduced in a certain percentage, depending on the purity of a starting material used for mass production, or by the addition of a recycled material. The amount of Co contained as an inevitable impurity is more preferably 0.06% or less by mass.

Ni is one of impurities possibly introduced into the sintered R-TM-B magnet from starting materials or in a production process. It is known that Ni replaces part of Fe, lowering the magnetic properties of R-TM-B magnets. Also, the addition of more than a certain level of Ni is undesirable because it drastically increases breakage. Ni inevitably introduced as an impurity from starting materials or in the production process is desirably less than 0.1% by mass, more desirably 0.08% or less by mass.

The sintered R-TM-B magnet may further contain M, wherein M is at least one selected from Zr, Nb, Hf, Ta, W, Mo, Al, Si, V, Cr, Ti, Ag, Mn, Ge, Sn, Bi, Pb and Zn. The addition of trace amounts of metal elements M improves coercivity by changing the properties of grain boundary phases, but the addition of large amounts of M reduces a volume ratio of R₂Fe₁₄B phases, resulting in low Br. Accordingly, M is preferably 3% or less by mass.

(2) Shape of Magnet

The sintered R-TM-B magnet of the present invention is preferably cylindrical. The cylindrical magnet preferably has radial or polar anisotropy. With a cylindrical (ring) shape, it can be assembled in a rotor by reduced number of steps.

A cylindrical magnet having a composition of the sintered R-TM-B magnet of the present invention has good corrosion resistance, and its breakage, chipping, cracking, etc. due to lowered mechanical strength by Co, if any, are extremely reduced, because of an extremely small amount of Co, if contained.

In the radially anisotropic R-T-B ring magnet, a ratio D1/D2 of the inner diameter D1 to the outer diameter D2 is preferably 0.7 or more.

When the radially anisotropic R-T-B ring magnet is multi-polar magnetized, the number of magnetic poles may be properly set depending on the specification of motors using the magnet.

In the polar-anisotropic R-T-B ring magnet, a ratio D1/D2 of the inner diameter D1 to the outer diameter D2 is preferably in a range expressed by the formula of D1/D2=1−K (π/P), wherein P represents the number of magnetic poles, and K is 0.51-0.70 at P=4, 0.57-0.86 at P=6, 0.59-0.97 at P=8, 0.59-1.07 at P=10, 0.61-1.18 at P=12, and 0.62-1.29 at P=14.

The polar-anisotropic R-T-B ring magnet may have multi-polar anisotropy having 4, 6, 8, 10, 12 or 14 magnetic poles, with a circular outer peripheral surface and a polygonal inner peripheral surface. In this case, the number of magnetic poles on the outer peripheral surface is preferably an integral multiple of the number of corners of the polygon. At least one middle position between magnetic poles on the outer peripheral surface is preferably aligned with at least one corner of the polygonal inner peripheral surface in a circumferential direction. The number of magnetic poles is preferably the same as or 2 times the number of corners of the polygon. The number of corners of the polygon may be properly set depending on the number of magnetic poles. The polygon is preferably a regular polygon. The inner diameter of the polygonal inner peripheral surface is defined as a diameter of a circle circumscribed on the polygon.

The present invention will be explained in more detail by Experiments below without intention of restriction.

Experiment 1

25 types of alloys having compositions comprising 24.80% by mass of Nd, 6.90% by mass of Pr, 1.15% by mass of Dy, 0.96% by mass of B, 0.15% by mass of Nb, 0.10% by mass of Al, and Ga and Cu in amounts of 0.1, 0.2, 0.3, 0.4 or 0.5% by mass for Ga, and 0.02, 0.1, 0.2, 0.3 or 0.4% by mass for Cu, as shown in Table 1, the balance being Fe and inevitable impurities, were prepared by a strip casting method. These alloys contained 0.06% by mass of Co as an inevitable impurity. The above Cu content included the amount (0.02% by mass) of Cu introduced as an inevitable impurity.

Each alloy was pulverized by a jet mill in a nitrogen gas containing 5000 ppm of oxygen, compression-molded in a magnetic field, sintered, heat-treated, and ground to obtain a test piece (3 mm×10 mm×40 mm) of the sintered R-TM-B magnet. Each test piece was subjected to a pressure cooker test (120° C., 100% RH, 2 atoms, and 96 hours), to determine weight loss (mg/cm²) by corrosion from the weight change before and after the test. The results are shown in Table 1. The results of each alloy were averaged for three tests (n=3).

TABLE 1

| Weight Loss By | | Cu Content (% by mass) | | | | |
|---|---|---|---|---|---|---|
| Corrosion (mg/cm²) | | 0.02 | 0.1 | 0.2 | 0.3 | 0.4 |
| Ga Content | 0.1 | 5.31 | 1.77 | 0.96 | 0.78 | 0.95 |
| (% by mass) | 0.2 | 1.63 | 0.80 | 0.75 | 0.59 | 0.52 |
| | 0.3 | 1.08 | 0.98 | 0.76 | 0.65 | 0.50 |
| | 0.4 | 0.75 | 0.59 | 0.50 | 0.47 | 0.50 |
| | 0.5 | 0.78 | 0.55 | 0.48 | 0.53 | 0.64 |

The addition of Ga or Ga+Cu reduced the weight loss by corrosion of the sintered R-TM-B magnet, resulting in drastically improved corrosion resistance. When Cu was not added except for 0.02% by mass of Cu as an inevitable impurity, the weight loss by corrosion was extremely large at the Ga content of 0.1% by mass, but lowered by increasing the Ga content, resulting in good corrosion resistance. When the Ga content was 0.1% by mass, the addition of Cu reduced the weight loss by corrosion, resulting in good corrosion resistance.

The inventors confirm that a sintered R-TM-B magnet meets the corrosion resistance standard required for automobiles (car electronic devices and HVs), when its weight loss by corrosion by a pressure cooker test at 120° C., 100% RH and 2 atom for 96 hours is less than 2 mg/cm².

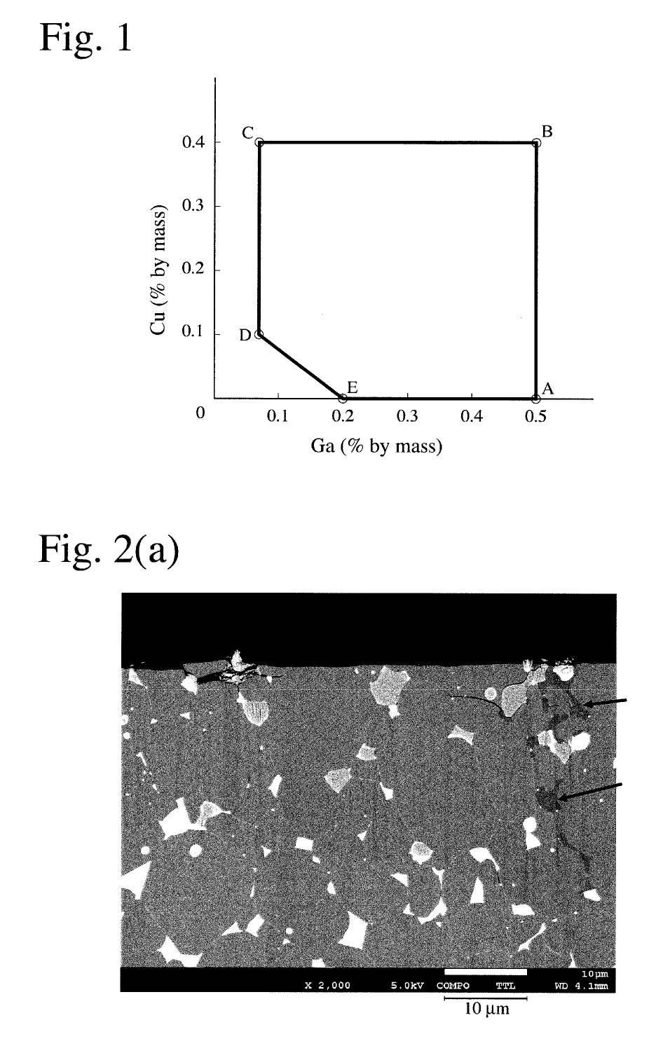

It has thus been found that the ranges of the amounts (% by mass) of Cu and Ga meeting the corrosion resistance standard with substantially no Co are in a region of a pentagon defined by points A, B, C, D and E, on an X-Y plane in which the X-axis represents the amount of Ga, and the Y-axis represents the amount of Cu, as shown in FIG. 1.

Experiment 2

Alloy A comprising 24.80% by mass of Nd, 6.90% by mass of Pr, 1.15% by mass of Dy, 0.96% by mass of B, 0.15% by mass of Nb, 0.10% by mass of Al, 0.30% by mass of Ga, and 0.15% by mass of Cu, the balance being Fe and inevitable impurities, was prepared by a strip casting method. Alloy A contained 0.06% by mass of Co as an inevitable impurity.

Alloys B to F were prepared in the same manner as Alloy A, except for changing the alloy composition as shown in Table 2. Alloys A to E are in a composition range of the sintered R-TM-B magnet of the present invention, and Alloy F is not in a composition range of the sintered R-TM-B magnet of the present invention.

TABLE 2

| Alloy | Nd | Pr | Dy | B | Nb | Al | Ga | Cu | Co⁽¹⁾ |
|---|---|---|---|---|---|---|---|---|---|
| A | 24.80 | 6.90 | 1.15 | 0.96 | 0.15 | 0.10 | 0.30 | 0.15 | 0.06 |
| B | 24.25 | 6.75 | 2.10 | 0.94 | 0.15 | 0.06 | 0.08 | 0.10 | 0.03 |
| C | 24.00 | 8.00 | 0.00 | 0.89 | 0.02 | 0.11 | 0.50 | 0.15 | 0.05 |
| D | 21.65 | 6.05 | 4.90 | 0.96 | 0.15 | 0.10 | 0.10 | 0.10 | 0.04 |
| E | 21.65 | 6.05 | 4.90 | 1.06 | 0.15 | 0.30 | 0.10 | 0.10 | 0.07 |
| F | 23.10 | 6.60 | 4.90 | 0.96 | 0.15 | 0.10 | 0.10 | 0.10 | 0.08 |

Note:
⁽¹⁾Co is an inevitable impurity.

Each of Alloys A to F was pulverized by a jet mill in a nitrogen gas containing 5000 ppm of oxygen, compression-molded in a magnetic field, sintered, heat-treated, and ground to obtain a test piece (3 mm×10 mm×40 mm) of the sintered R-TM-B magnet. Each test piece was measured with respect to a residual magnetic flux density Bᵣ and coercivity H_{cJ}, and weight loss by corrosion. The weight loss by corrosion is expressed by weight difference before and after the pressure cooker test (120° C., 100% RH, 2 atoms, and 96 hours). The results are shown in Table 3. The pressure cooker test results of each alloy were averaged for three tests (n=3).

Among the test pieces produced in Experiment 1, Alloy 1 containing 0.1% by mass of Ga and 0.02% by mass of Cu, Alloy 2 containing 0.1% by mass of Ga and 0.4% by mass of Cu, Alloy 3 containing 0.5% by mass of Ga and 0.02% by mass of Cu, and Alloy 4 containing 0.5% by mass of Ga and 0.4% by mass of Cu were measured with respect to a residual magnetic flux density Bᵣ and coercivity H_{cJ}. The results are also shown in Table 3.

TABLE 3

| | Weight Loss By | Bᵣ | H_{cJ} |
|---|---|---|---|
| Alloy | Corrosion (mg/cm²) | (T) | (kA/m) |
| A | 0.85 | 1.371 | 1306 |
| B | 1.86 | 1.345 | 1473 |
| C | 0.51 | 1.370 | 1500 |
| D | 0.92 | 1.274 | 1765 |
| E | 0.91 | 1.269 | 1723 |
| F* | 4.20 | 1.250 | 1790 |
| 1* | 5.31 | 1.365 | 1296 |
| 2 | 0.95 | 1.355 | 1256 |
| 3 | 0.78 | 1.360 | 1240 |
| 4 | 0.64 | 1.352 | 1337 |

Note:
*Comparative Example.

It is clear that Alloys A-E and Alloys 2-4 within the composition range of the sintered R-TM-B magnet of the present invention had small weight loss by corrosion, as well as high residual magnetic flux density Bᵣ and coercivity H_{cJ}. It is presumed that Alloy F had poor corrosion resistance, because the total amount of Pr and Dy exceeded the range of the rare earth elements defined in the present invention.

Experiment 3

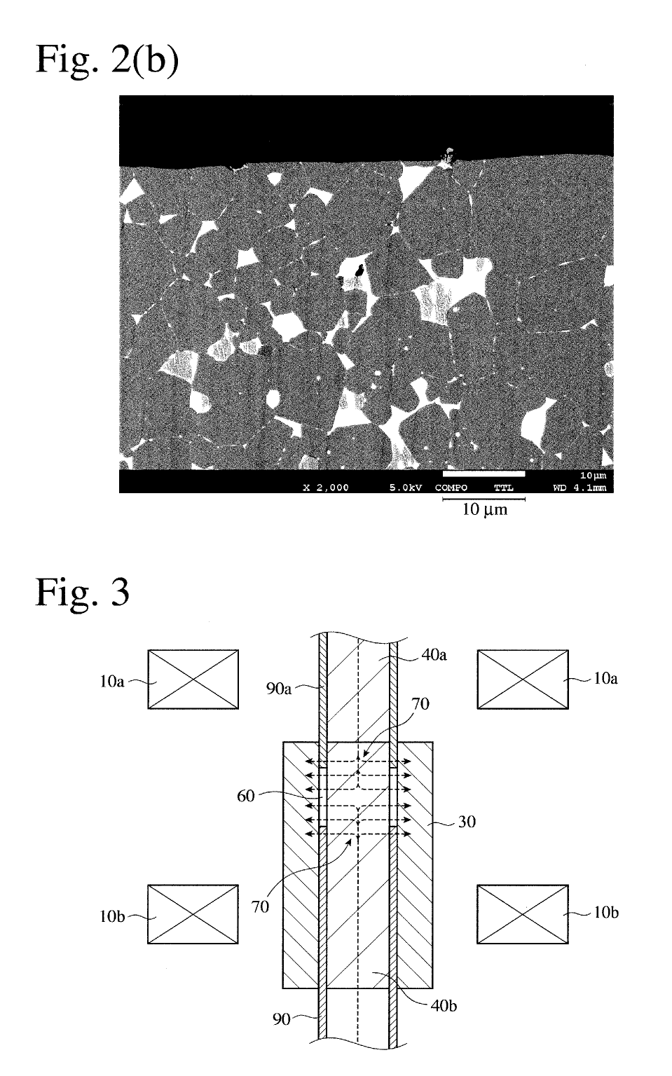

With respect to Alloy 1 containing 0.1% by mass of Ga and 0.02% by mass of Cu, and Alloy 4 containing 0.5% by mass of Ga and 0.4% by mass of Cu, which were obtained in Experiment 1, a pressure cooker test was conducted at 120° C., 100% RH, and 2 atoms for 24 hours, to observe their corrosion after the test by SEM. The results are shown in FIG. 2.

It was confirmed that corrosion proceeded in a depth direction in Alloy 1 [shown by arrows in FIG. 2(a)], while no corrosion proceeded in Alloy 4 [FIG. 2(b)].

Experiment 4

To evaluate the influence of the Co content on the mechanical strength of the sintered R-TM-B magnet, the following experiment was conducted. 13 types of alloys having compositions comprising 24.25% by mass of Nd, 6.75% by mass of Pr, 2.1% by mass of Dy, 0.96% by mass of B, 0.15% by mass of Nb, 0.06% by mass of Al, 0.08% by mass of Ga, and Co in an amount of 0.0, 0.06, 0.08, and 0.1-1.0% by mass (increment: 0.1% by mass), the balance being Fe and inevitable impurities, were prepared by a strip casting method. Though high-purity metals were used in the experiment, trace amounts of inevitable impurities were contained. Accordingly, an alloy expressed by having the Co content of “0.0% by mass” may contain Co in a smaller amount than the detectable level (0.01% by mass).

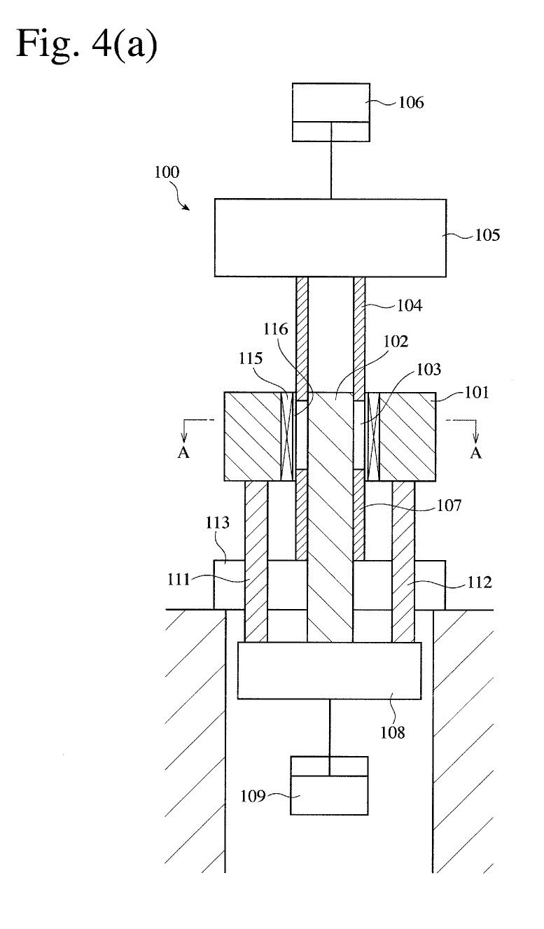

Each alloy was pulverized by a jet mill in a nitrogen gas containing 5000 ppm of oxygen to produce fine powder. Each fine powder was compression-molded at 98 MPa in a magnetic field (intensity: 318 kA/m) in the molding apparatus shown in FIG. 3, to obtain a green body of a radially anisotropic R-TM-B ring magnet (outer diameter: 41.8 mm, inner diameter: 32.5 mm, and height: 47.2 mm). With respect to each alloy, 10 green bodies were produced.

The apparatus for molding the radially anisotropic R-TM-B ring magnet comprises a die comprising upper and lower columnar cores 40a, 40b (made of Permendur), an outer cylindrical die 30 (made of SK3), and upper and lower non-magnetic cylindrical punches 90a, 90b; a cavity 60, which is a space surrounded by them; and a pair of magnetic-field-generating coils 10a, 10b disposed around the upper core 40a and the lower core 40b. The upper core 40a is movable away from the lower core 40b; the upper core 40a and the upper punch 90a are independently movable up and down; and the upper punch 90a is movable away from the cavity 60. A radial magnetic field expressed by magnetic force lines 70 is applicable to the cavity 60 through the closed upper core 40a and lower core 40b.

With a sintering columnar jig (SUS403 having a linear thermal expansion coefficient of 11.4×10⁻⁶, outer diameter: 29.0 mm) inserted into the green body, the green body was placed on a heat-resistant Mo plate in a Mo vessel, and sintered at 1080° C. for 2 hours in vacuum. The sintering jig was coated with a slurry of Nd₂O₃ in an organic solvent on the outer peripheral surface before use. The sintered body was ground on the end surfaces and outer and inner peripheral surfaces, to obtain 13 radially anisotropic R-TM-B ring magnets 401 to 413 having different Co contents. It was observed by the naked eye whether the radially anisotropic R-TM-B ring magnets were broken or not. The results are shown in Table 4. The ring magnets 401 to 403 are Reference Examples, which have the Ga contents outside the present invention, but the Co contents are less than 0.1% by mass, within the range of the present invention. The ring magnets 404 to 413 are Comparative Examples, in which the Co contents are 0.1% or more by mass, outside the range of the present invention.

TABLE 4

| Ring | Co Content | Number of Breakage |
|---|---|---|
| Magnet | (% by mass) | After Cutting |
| 401* | 0.0 | 0 |
| 402* | 0.06 | 0 |
| 403* | 0.08 | 0 |
| 404** | 0.1 | 3 |
| 405** | 0.2 | 7 |
| 406** | 0.3 | 10 |
| 407** | 0.4 | 10 |
| 408** | 0.5 | 10 |
| 409** | 0.6 | 10 |
| 410** | 0.7 | 10 |
| 411** | 0.8 | 10 |
| 412** | 0.9 | 10 |
| 413** | 1.0 | 10 |

Note:
*Reference Example.
**Comparative Example.

The results shown in Table 4 indicate that breakage occurred in the sintered ring magnets when the Co content was 0.1% or more by mass, and that more breakage occurred as the Co content increased.

Experiment 5

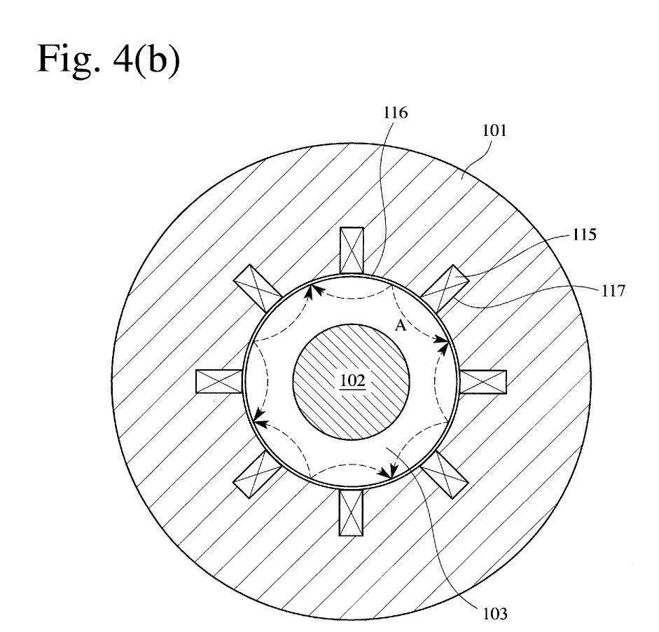

Each fine powder of 13 types of alloys produced in the same manner as in Experiment 4 was compression-molded at 80 MPa in a pulse magnetic field (the same intensity for each fine powder) in the molding apparatus 100 shown in FIG. 4, to obtain a green body (outer diameter: 31.5 mm, inner diameter: 20.3 mm, and height: 27.8 mm) of a polar-anisotropic R-TM-B ring magnet having 8 magnetic poles on the outer peripheral surface. With respect to each alloy, 10 green bodies were produced.

The apparatus 100 for molding the polar-anisotropic R-TM-B ring magnet in a magnetic field comprises, as shown in FIG. 4(a), a magnetic die 101, and a non-magnetic columnar core 102 concentrically disposed in an annular space of the die 101, the die 101 being supported by supports 111, 112, and both of the core 102 and the supports 111, 112 being supported by a lower frame 108. An upper, cylindrical, non-magnetic punch 104, and a lower, cylindrical, non-magnetic punch 107 are inserted into a molding space 103 between the die 101 and the core 102. The lower punch 107 is fixed to a substrate 113, and the upper punch 104 is fixed to an upper frame 105. The upper frame 105 and the lower frame 108 are connected to an upper cylinder 106 and a lower cylinder 109, respectively.

FIG. 4(b) shows a cross section taken along the line A-A in FIG. 4(a). Pluralities of grooves 117 are formed on an inner surface of the cylindrical die 101, and a magnetic-field-generating coil 115 is embedded in each groove 117. The die 101 is provided with an annular non-magnetic sleeve 116 covering the grooves on the inner surface. A molding space 103 is defined by the annular sleeve 116 and the core 102. In FIG. 4(b), current flows in the magnetic-field-generating coil 115 in each groove 117 in a perpendicular direction to the paper surface, and circumferentially adjacent coils are connected to flow current alternately in opposite directions. With current flowing in the magnetic-field-generating coils 115, a magnetic flux shown by the arrows A is generated in the molding space 103, so that magnetic poles (8 poles in the figure) having circumferentially alternating polarities of S, N, S, N . . . are formed at points (start and end points of each arrow) of the annular sleeve, with which magnetic flux came into contact.

The resultant green body was placed on a heat-resistant Mo plate in a Mo vessel, and sintered at 1080° C. for 2 hours in vacuum. The end surfaces and outer and inner peripheral surfaces of the sintered body were ground to produce 13 types of polar-anisotropic R-TM-B ring magnets 501 to 513 having different Co contents. It was observed by the naked eye whether the polar-anisotropic R-TM-B ring magnets were broken or not. The results are shown in Table 5. The ring magnets 501-503 are Reference Examples, in which their Ga contents are outside the present invention, but their Co contents are less than 0.1% by mass, within the range of the present invention. The ring magnets 504-513 are Comparative Examples, in which their Co contents are 0.1% or more by mass, outside the range of the present invention.

TABLE 5

| Ring | Co Content | Number of Breakage |
|---|---|---|
| Magnet | (% by mass) | After Cutting |
| 501* | 0.0 | 0 |
| 502* | 0.06 | 0 |
| 503* | 0.08 | 0 |
| 504** | 0.1 | 5 |
| 505** | 0.2 | 10 |
| 506** | 0.3 | 10 |
| 507** | 0.4 | 10 |
| 508** | 0.5 | 10 |
| 509** | 0.6 | 10 |
| 510** | 0.7 | 10 |
| 511** | 0.8 | 10 |
| 512** | 0.9 | 10 |
| 513** | 1.0 | 10 |

Note:
*Reference Example.
**Comparative Example.

The results shown in Table 5 indicate that breakage occurred in the sintered ring magnets when the Co content was 0.1% or more by mass, and that more breakage occurred as the Co content increased.

Experiment 6

Radially anisotropic sintered ring magnets of the present invention were produced in the same manner as in Experiment 4, except for using 25 types of fine alloy powders prepared in the same manner as in Experiment 1. No breakage occurred after grinding in any of 25 types of radially anisotropic sintered ring magnets.

Experiment 7

Polar anisotropic sintered ring magnets of the present invention were produced in the same manner as in Experiment 5, except for using 25 types of fine alloy powders produced in the same manner as in Experiment 1. No breakage occurred after grinding in any of 25 types of radially anisotropic sintered ring magnets.

1. A sintered R-TM-B magnet comprising 24.5-34.5% by mass of R, wherein R is at least one selected from rare earth elements including Y, 0.85-1.15% by mass of B, less than 0.1% by mass of Co, 0.07-0.5% by mass of Ga, and 0-0.4% by mass of Cu, the balance being Fe and inevitable impurities; the amounts (% by mass) of Ga and Cu being in a region of a pentagon defined by a point A (0.5, 0.0), a point B (0.5, 0.4), a point C (0.07, 0.4), a point D (0.07, 0.1) and a point E (0.2, 0.0), on an X-Y plane in which an X-axis represents the amount of Ga, and a Y-axis represents the amount of Cu.

2. The sintered R-TM-B magnet according to claim 1, further comprising 3% or less by mass of M, wherein M is at least one selected from Zr, Nb, Hf, Ta, W, Mo, Al, Si, V, Cr, Ti, Ag, Mn, Ge, Sn, Bi, Pb and Zn.

3. The sintered R-TM-B magnet according to claim 1, wherein the amounts (% by mass) of Ga and Cu are in a region of a pentagon defined by a point A (0.5, 0.0), a point B (0.5, 0.4), point C′ (0.1, 0.4), point D′ (0.1, 0.1) and a point E (0.2, 0.0), on an X-Y plane in which the X-axis represents the amount of Ga, and the Y-axis represents the amount of Cu.

4. The sintered R-TM-B magnet according to claim 1, wherein said sintered R-TM-B magnet is a radially anisotropic, cylindrical magnet or a polar-anisotropic, cylindrical magnet.

5. The sintered R-TM-B magnet according to claim 1, wherein its weight loss by corrosion by a pressure cooker test at 120° C., 100% RH and 2 atom for 96 hours is less than 2 mg/cm².
